(19) United States
(12) Patent Application Publication
(10) Pub. No.: US 2026/0247202 A1
(43) Pub. Date: Aug. 20, 2026

(54) SYSTEMS AND METHODS FOR NETWORK BASED BATTERY MANAGEMENT

(71) Applicant: T-Mobile Innovations LLC, Overland Park, KS (US)

(72) Inventor: Timur KOCHIEV, Irvine, CA (US)

(21) Appl. No.: 19/058,551

(22) Filed: Feb. 20, 2025

(51) Int. Cl. H04W 28/02; H04B 7/0413; H04W 52/02; H04W 72/0453; H04W 72/1268

(52) U.S. Cl. CPC H04W 28/0221; H04B 7/0413; H04W 52/0277; H04W 72/0453; H04W 72/1268

(57) ABSTRACT

Systems, methods and devices are provided for battery management. The method includes receiving, by a wireless network communicatively connected to a wireless device using a network slice, a battery status for the wireless device, in response to receiving the battery status, determining, by the wireless network, a slice configuration for the network slice for the wireless device based on the battery status and adjusting session configurations for the network slice for the wireless device utilizing the slice configuration.

### TECHNICAL BACKGROUND

For wireless devices, or user equipment, connecting to a 5G New Radio (5G NR) network, network slicing may be an available feature of the network. Network slicing allows a single network to be divided into multiple slices. Each network slice can have its own set of configurations. For example, a network slice may be established and configured for a mobile wireless device with specific requirements, such as a network setting that requires lower power consumption than normal operations.

### OVERVIEW

Exemplary embodiments described herein include systems, methods, and processing nodes for network-based battery management. An exemplary method includes receiving, by a wireless network communicatively connected to a wireless device using a network slice, a battery status for the wireless device, in response to receiving the battery status, determining, by the wireless network, a slice configuration of the network slice for the wireless device based on the battery status and adjusting session configurations for the network slice for the wireless device utilizing the slice configuration.

Further exemplary embodiments include a system for network-based battery management. The system includes a wireless device connected to a network slice of the wireless network. The wireless network including a computing device communicatively connected to the wireless device, wherein the computing device includes at least one processor configured to receive a battery status for the wireless device, and in response to receiving the battery status, determine a slice configuration of the network slice for the wireless device based on the battery status and adjust session configurations for the wireless device based on the slice configuration.

In yet a further exemplary embodiment, a non-transitory computer readable medium is provided. The non-transitory computer-readable medium stores instructions, when executed by a processor, configuring the processor to receive a battery status for a wireless device using a network slice, in response to receiving the battery status, determine a slice configuration of the network slice for the wireless device based on the battery status and adjust session configurations for the wireless device based on the slice configuration.

### BRIEF DESCRIPTION OF THE DRAWINGS

FIG. 1 illustrates an exemplary system for wireless communication in accordance with various aspects of the present disclosure;

FIG. 2 illustrates an exemplary process flow for network based wireless device battery management;

FIG. 3 illustrates an example of a computing device in accordance with aspects of this disclosure; and

FIG. 4 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a 5G core network provides network slices to allow for many virtualized networks to be provided on the hardware architecture of the cellular network operator. One use of network slicing is to provide different levels of Quality of Service (QoS) depending on the needs of the wireless devices using the network slices and the needs of the network operator providing them. Network slices can be created and configured for many different levels of QoS. For example, a network slice may be created with reduced uplink operations to reduce power consumption of a device.

User devices, such as smartphones, often perform upload operations that are battery consuming. In some situations, when a device is running low on battery, the device may reduce much of its own computing power to reduce power consumption, but the connection to the network may still consume too much power from the device. To alleviate this problem, the 5G network may be capable of reducing the uplink operations, which are often more power consuming than downlink operations, for the device through slice configuration. For example, the session for the device may be modified to reduce the uplink operations once the network detects that the battery of the device is running low. In some embodiments, the network can differentiate between traffic types (e.g., emergency services or high-priority data) With emergency services or high-priority data, it may be critical to move these devices to an energy-saving network slice.

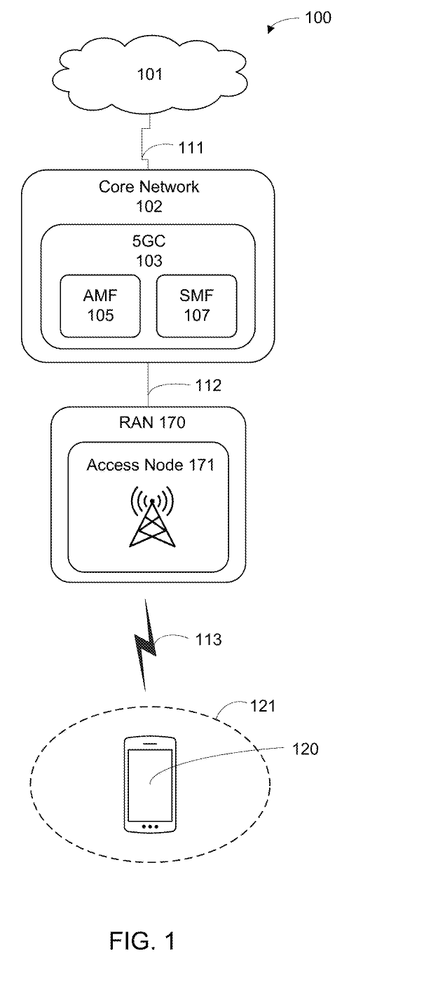

These and other examples will be described in greater detail below in relation to FIGS. 1-4.

FIG. 1 depicts an exemplary system 100 for network node switching. System 100 includes a communication network 101, a core network 102, a radio access network (RAN) 170 and at least one wireless device 120.

Core network 102 is connected to communication network 101 over communication link 111. Core network 102 includes a 5G core (5GC) 103. 5GC 103 as used herein are core network components used for managing data for 5G networks. In embodiments, core network 102 may be configured to detect that a device, such as wireless device 120, is being served by a network slice. In embodiments, core network 102 is configured to receive a battery status of a device, such as wireless device 120, connected to the core network 102. It should be noted that core network 102 may include other components used for managing data for networks not described herein, such as a satellite core network. Furthermore, it should also be noted that in other embodiments, the core network 102 may have other types of core architecture (e.g., 6G core architecture) that at least perform some similar functions as and/or share at least some components with the 5GC 103 with respect to network slicing for wireless devices.

In embodiments, 5GC 103 includes an access and mobility function (AMF) 105. The AMF 105 receives connection and session related information from the wireless devices 120 and is responsible for handling connection and mobility management tasks on a 5G network. For example, AMF 105 may receive a low battery status notification from a user device, such as wireless device 120, and communicate with a network slice selection function (NSSF) to determine a slice configuration based on the low battery status notification. In instances, the low battery notification may include a low battery indication (LBI) sent by the user device. In embodiments, the low battery status may be included in a radio resource control (RRC) message. In some embodiments, the low battery status may be included in a non-access stratum (NAS) signaling message.

In embodiments, 5GC 103 includes a session management function (SMF) 107. The SMF 107 receives slice configuration for a network slice serving a device, such as wireless device 120, and is responsible for adjusting session configurations for the network slice. In embodiments, SMF 107 may adjust a session based on receiving a new slice configuration from AMF 105. For example, SMF 107 may reconfigure a PDU session for the user device, such as wireless device 120, based on the slice configuration received. In embodiments, SMF 107 may update a user plane function (UPF) based on the slice configurations determined by AMF 105. In embodiments, a policy control function (PCF) may modify quality of service (QoS) for the connection based on a low battery status notification received from a user device. For example, SMF 107 may modify a UPF based on the modified QoS policies.

The RAN 170 includes access nodes 171. In embodiments, the access nodes 171 include an evolved Node B (eNodeB) and a next generation Node B (gNodeB). As used herein, an eNode B is a base station in LTE/4G networks used for connecting a user device, such as wireless device 120, to core network 102. A gNodeB, as used herein, is a base station in 5G networks and/or other networks used for connecting a user device to core network 102. The gNodeB may include, for example, centralized units (CUs) and distributed units (DUs).

RAN 170 is connected to core network 102 over communication link 112. RAN 170 may include other devices and additional nodes not described herein. For example, RAN 170 may include devices used for forwarding RRC messages with low battery status indication from wireless device 120 to core network 102.

System 100 also includes wireless device 120. In embodiments, system 100 may include multiple wireless devices. Wireless device 120 is configured to operate in one or more coverage areas 121. Wireless device 120 may be an end-user wireless device. Wireless device 120 may include any device configured to send and receive data. In embodiments, wireless device 120 communicates with RAN 170 over communication link 113. Examples of communication link 113 may include 5G network, 4G LTE, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The UPF accesses a data network, such as network 101, and performs operations such as packet routing and forwarding, packet inspection, policy enforcement for the user plane, QoS handling, etc. The control plane functions may include, for example, a NSSF, a network exposure function (NEF), a network repository function (NRF), a PCF, a unified data management (UDM) function, an application function (AF), an AMF, such as AMF 105, an authentication server function (AUSF), and a SMF, such as SMF 107. Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF 105, SMF 107, and NEF. The UDM may function as a stateful message store, holding information in local memory. The NSSF can be used by AMF 105 to assist with the selection of network slice instances that will serve a particular need for a device. Further, the NEF provides a mechanism for securely exposing services and features of the core network.

In instances, the UDM may include a mapping of DNNs to network slice selection assistance information (nSSAI) associated with a wireless device 120. nSSAI includes a set of single nSSAI(S-nSSAI). Each S-nSSAI may include a slice/service type and a slice differentiator (SD). For example, AMF 105 may query UDM for S-nSSAIs associated with a DNN. In an example, AMF 105 may use NSSF for selecting a S-nSSAI based on additional requirements, such as data priority traffic type. In some embodiments, UDM may detect a change in configuration for a slice, such as determined based on battery status of a device and notify AMF 105 of the change. Once notified, AMF 105 updates nSSAI by changing the S-nSSAIs for the slice with the required configurations.

Although one core network 102 is shown, multiple core networks 102 may be utilized. Alternatively, the single core network 102 may include a distributed, cloud-native, converged core gateway. Thus, the converged core gateway could connect an evolved packet core (EPC) to 5GC 103 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format - including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access nodes 171. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with eNodeB and others may communicate with gNodeB.

In additional embodiments, access nodes 171 may comprise two co-located cells, or antenna/transceiver combinations that are mounted on the same structure. Alternatively, access nodes 171 may comprise a short range, low power, small-cell access node such as a microcell access node, a picocell access node, a femtocell access node, and/or a home eNodeB device. As will be further described below, functionality for network node switching may be included within the access nodes 171.Access nodes 171 can be configured to deploy one or more different carriers, utilizing one or more RATs. For example, a gNodeB may support 5G NR and an eNodeB may provide LTE coverage. It would be evident to one of ordinary skill in the art, in light of this disclosure, the many other combinations of access nodes and carriers could be deployed.

The access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 120 may include any wireless device included in a wireless network. For example, the term “wireless device” may include a relay node, which may communicate with an access node. The term “wireless device” may also include an end-user wireless device, which may communicate with access nodes 171 through the relay node. The term “wireless device” may further include an end-user wireless device that communicates with the access node 171 directly without being relayed by a relay node.

Wireless device 120 may be any device, system, combination of devices, or other such communication platform capable of communicating wirelessly with access nodes 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless device 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network-based battery management may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

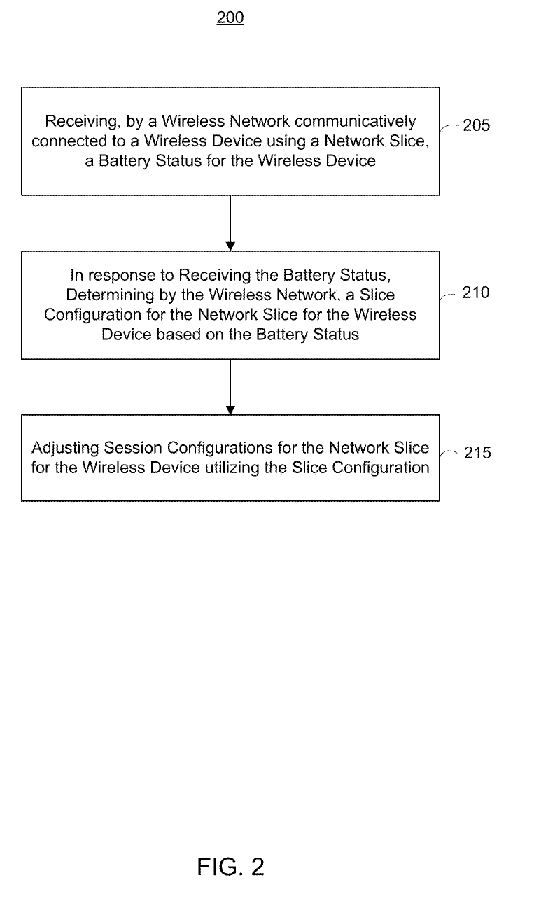

With reference to FIG. 2, a flow diagram of method 200 for network-based battery management is presented. Method 200 includes, at step 205, receiving, by a wireless network communicatively connected to a wireless device using a network slice, a battery status for the wireless device, such as wireless device 120.

At step 210, method 200 includes, in response to receiving the battery status, determining, by the wireless network, a slice configuration of the network slice for the wireless device based on the battery status. In embodiments, a machine learning model determines the slice configuration based on the battery status for the wireless device.

In embodiments, the machine learning model may have been trained using training data with correlated different battery statuses of wireless devices with different slice configurations. The battery status of a wireless device may include state of charge (SoC) battery voltage, battery capacity, battery discharge rate, and the like.

In embodiments, method 200 may include, at step 215, adjusting session configurations for the network slice for the wireless device based on the slice configuration. In embodiments, adjusting the session configurations may include selecting a new network slice for the wireless device. In some embodiments, adjusting the session configurations may include modifying Uplink (UL) operations in response to receiving a low battery status for the wireless device. For example, modifying UL operations may include reducing Multiple-Input, Multiple-Output (MIMO) layers in response to receiving a low battery status for the wireless device. In an example, modifying UL operations may include disabling one or more component carriers (CC) of a carrier aggregation (CA) in response to receiving a low battery status for the wireless device.

In instances, adjusting the session configurations may include modifying Downlink (DL) operations in response to receiving a low battery status for the wireless device. For example, modifying DL operations may include reducing MIMO layers for DL transmission in response to receiving a low battery status for the wireless device, such as through dynamic MIMO rank control. In an example, modifying DL operations may include using a lower modulation and coding scheme (MCS) in response to receiving a low battery status for the wireless device. In an embodiment, modifying DL operations may include using highly focused beamforming. For example, a base station of a NR 5G network may direct a highly focused beam towards a wireless device, reducing active time of receiving a transmission by the wireless device.

In instances, the training data for training the machine learning model may include historical battery data of various wireless devices. The historical battery data may include battery status correlated to session configuration adjustments. For example, the training data may include battery SoC of each of the various wireless devices correlated to MIMO reduction. In instances, the historical battery data may include battery status correlated to session configuration prior to adjustment and battery status correlated to session configuration after adjustment. For example, the historical battery data may include battery discharge rate for each of the various wireless devices during usage of session prior to adjustment and after adjustment.

In embodiments, method 200 may include predicting device performance for device utilizing the slice configuration using machine learning processes. The device performance may be predicted based on historical battery data used for optimizing operation, through session adjustment. For example, method 200 may predict device performance for a session configuration adjustment based on historical battery data for the wireless device that includes battery statuses correlated to the same session configuration to be applied, such as battery status changes after a CA adjustment-based session configuration.

Session adjustment may be used for optimizing operations on commonly used UL carriers and number of layers in certain RF conditions. Features of optimizing operations may include battery rates in various UL configurations, impact of RF conditions on power usage (e.g., high pat loss areas vs low), frequency and type of UL CA/MIMO adjustments made previously based on battery status, typical battery levels during high-demand scenarios, such as video uploads or data-intensive tasks, and the like.

In some embodiments, methods 200 may include additional steps or operations. Furthermore, the methods may include steps shown in each of the other methods. As one of ordinary skill in the art would understand, method 200 may be integrated in any useful manner and the steps may be performed in any useful sequence.

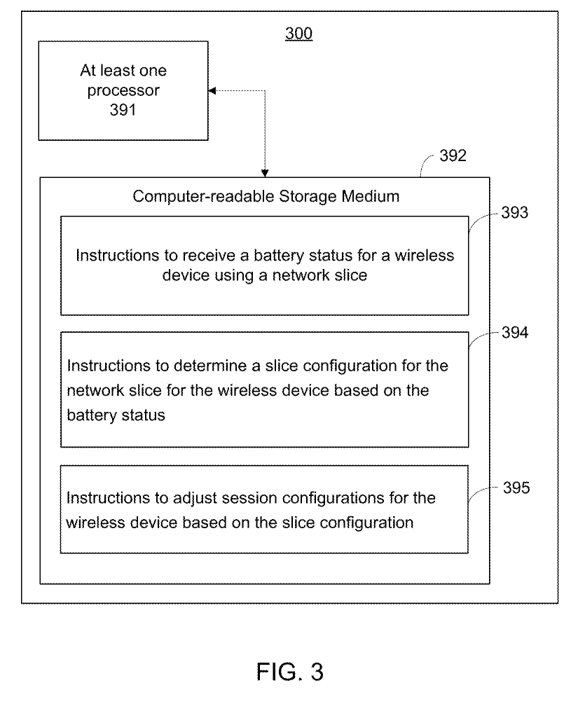

Now referring to FIG. 3, an example computing device 300 is presented. In embodiments, computing device 300 may include a node device, such as devices operating within communication network described in reference to FIG. 1. In this example, computing device 300 includes at least one processor 391 communicably coupled to a computer-readable storage medium 392. The at least one processor 391 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 392. In instances, at least one processor 391 may include electronic circuitry for performing instructions described in this disclosure.

In instances, computer-readable storage medium 392 may be any medium suitable for storing executable instructions. In examples, without limitation, computer-readable storage medium 392 may include read-only memory (ROM), random-access memory (RAM), erasable electrically programmable ROM (EEPROM), Solid State Drive (SSD), optical disc, and the like. Computer-readable medium storage 392 may be disposed within computing device 300. In embodiments, computer-readable storage medium 392 may be external, and communicably connected, to computing device 300. The instruction stored on computer-readable storage medium may be used to implement method steps described in reference to FIG. 2.

In this example, computer-readable storage medium 392 is encoded with a set of instructions 393, 394 and 395. In embodiments, executable instructions included in each block may be included in different blocks shown and blocks not shown.

Instruction 393, when executed by at least one processor 391, configures the at least one processor 391 to receive a battery status for a wireless device using a network slice.

Instruction 394, when executed by at least one processor 391, configures the at least one processor 391 to determine a slice configuration for the network slice for the wireless device based on the battery status. In embodiments, adjusting session configurations may include modifying UL operations in response to receiving a low battery status for the wireless device. In instances, modifying UL operations comprises reducing MIMO layers in response to receiving a low battery status for the wireless device. In an embodiment, modifying UL operations comprises disabling one or more CC of a CA in response to receiving a low battery status for the wireless device. UL CA and UL MIMO increase throughput, but also demand more transmission power and processing from the mobile device, resulting in quicker battery drain.

In embodiments, computer-readable storage medium 392 may include instruction 395 configuring the at least one processor 391 to adjust session configurations for the wireless device based on the slice configuration. In embodiments, computer-readable storage medium 392 may include instructions configuring the at least one processor 391 to establish a new session for the wireless device based on the slice configuration. In some embodiments, computer-readable storage medium 392 may include instructions configuring the at least one processor 391 to determine the slice configuration based on the battery status for the wireless device as a function of a machine learning model.

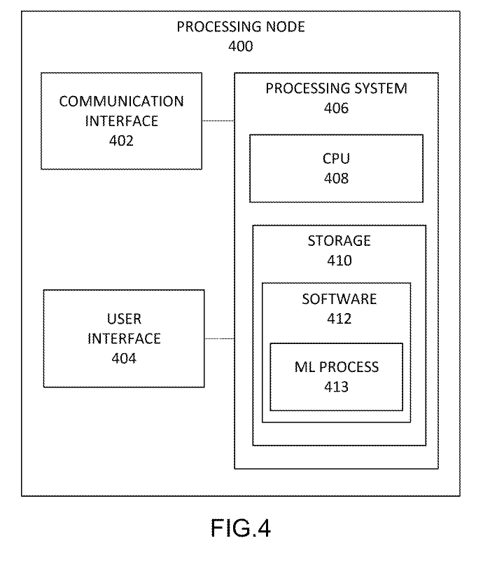

Now referring to FIG. 4, an example processing node 400, which may be configured to perform the methods and operations disclosed herein for battery management. The processing node 400 includes a communication interface 402, user interface 404, and processing system 406 in communication with communication interface 402 and user interface 404. Communication interface 402 may include hardware components, such as network communication ports, devices, routers, wires, antenna, transceivers, etc. User interface 404 may include hardware components, such as touch screens, buttons, displays, speakers, etc.

Processing system 406 includes a central processing unit (CPU) or processor 408 and storage 410. Storage 410 may include a disk drive, flash drive, memory circuitry, or other memory device including, for example, a buffer. Storage 410 can store software 412 which is used in the operation of the processing node 400. Software 412 may include computer programs, firmware, or some other form of machine-readable instructions, including an operating system, utilities, drivers, network interfaces, applications, or some other type of software. In instances, software 412 includes machine learning processes 413, such as a machine learning model. In instances, the machine learning processes include training data containing correlations that machine-learning processes 413 may use to model relationships between two or more categories of data elements. For example, machine learning processes 413 may be designed and configured to generate a machine learning model used for determining a slice configuration based on a device battery status, as described in reference to FIGS. 2 and 3.

In embodiments, machine learning processes 413 may be used for determining device performance. In instances, machine learning processes 413 may generate training data using historical battery status notifications for a device. In instances, machine learning processes 413 may use training data that includes historical data for similar devices to train a machine learning model. For example, a machine learning model trained with data for a similar device may be used until training data with historical data for the device can be generated.

In instances, machine learning processes 413 may be used for determining battery consumption rates in various UL configurations. In embodiments, machine learning processes 413 may be used for determining impact of radio frequency changes to power usage of the device. For example, training data may be generated with correlations of battery status to session adjustments for a device. In some embodiments, machine learning processes 413 may be used for determining battery levels during high demand scenarios, such as video upload or data-intensive tasks. In an example, a machine learning model may be trained using training data that includes correlations of battery status to network activity type.

Processing system 406 may include a processor 408 and other circuitry to retrieve and execute software 412 from storage 410, which may be internal or external to the processing system 406. Processing node 400 may further include other components such as a power management unit, a control interface unit, etc., which are omitted for clarity. Communication interface 402 permits processing node 400 to communicate with other network elements. User interface 404 permits the configuration and control of the operation of processing node 400. Processing node 400 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 412 may include the instructions described in reference to FIG. 3.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a wireless network communicatively connected to a wireless device using a network slice, a battery status for the wireless device; and
in response to receiving the battery status, determining, by the wireless network, a slice configuration of the network slice for the wireless device based on the battery status; and
adjusting session configurations for the network slice for the wireless device utilizing the slice configuration.

2. The method of claim 1, wherein adjusting session configurations comprises selecting a new network slice for the wireless device.

3. The method of claim 1, wherein adjusting session configurations comprises modifying Uplink (UL) operations in response to receiving a low battery status for the wireless device.

4. The method of claim 3, wherein modifying UL operations comprises reducing Multiple-Input, Multiple-Output (MIMO) layers in response to receiving a low battery status for the wireless device.

5. The method of claim 3, wherein modifying UL operations comprises disabling one or more component carriers (CC) of a carrier aggregation (CA) in response to receiving a low battery status for the wireless device.

6. The method of claim 1, wherein a machine learning model determines the slice configuration based on the battery status for the wireless device.

7. The method of claim 6, wherein the machine learning model is trained based on training data that includes battery statuses of multiple wireless devices.

8. A system, the system comprising:
a wireless device connected to a network slice; and
a wireless network comprising at least one computing device communicatively connected to the wireless device, wherein the at least one computing device is configured to:
receive a battery status for the wireless device;
in response to receiving the battery status, determine a slice configuration of the network slice for the wireless device based on the battery status; and
adjust session configurations for the wireless device based on the slice configuration.

9. The system of claim 8, wherein adjusting session configurations comprises selecting a new network slice for the wireless device.

10. The system of claim 8, wherein adjusting session configurations comprises modifying Uplink (UL) operations in response to receiving a low battery status for the wireless device.

11. The system of claim 10, wherein modifying UL operations comprises reducing Multiple-Input, Multiple-Output (MIMO) layers in response to receiving a low battery status for the wireless device.

12. The system of claim 10, wherein modifying UL operations comprises disabling one or more component carriers (CC) of a carrier aggregation (CA) in response to receiving a low battery status for the wireless device.

13. The system of claim 8, wherein the wireless network is further configured to determine the slice configuration based on the battery status for the wireless device as a function of a machine learning model.

14. The system of claim 13, wherein the battery status is determined using a machine learning model, and wherein the machine learning model is trained using training data that includes battery statuses of multiple wireless devices.

15. A non-transitory computer-readable medium storing instructions, when executed by at least one processor, configuring the at least one processor to:
receive a battery status for a wireless device using a network slice;
in response to receiving the battery status, determine a slice configuration of the network slice for the wireless device based on the battery status; and
adjust session configurations for the wireless device based on the slice configuration.

16. The non-transitory computer-readable medium storing instructions of claim 15, wherein the at least one processor is further configured to establish a new session for the wireless device based on the slice configuration.

17. The non-transitory computer-readable medium storing instructions of claim 15, wherein adjusting session configurations comprises modifying Uplink (UL) operations in response to receiving a low battery status for the wireless device.

18. The non-transitory computer-readable medium storing instructions of claim 17, wherein modifying UL operations comprises reducing Multiple-Input, Multiple-Output (MIMO) layers in response to receiving a low battery status for the wireless device.

19. The non-transitory computer-readable medium storing instructions of claim 17, wherein modifying UL operations comprises disabling one or more component carriers (CC) of a carrier aggregation (CA) in response to receiving a low battery status for the wireless device.

20. The non-transitory computer-readable medium storing instructions of claim 15, wherein the at least one processor is further configured to determine the slice configuration based on the battery status for the wireless device as a function of a machine learning model.
